(19) United States
(12) Patent Application Publication
(10) Pub. No.: US 2026/0134494 A1
(43) Pub. Date: May 14, 2026

(54) SYSTEM AND METHOD FOR ACADEMIC DEGREE ATTESTATION BASED ON SMART CONTRACT

(71) Applicant: Cleveland State University, Cleveland, OH (US)

(72) Inventor: WENBING ZHAO, CLEVELAND, OH (US)

(21) Appl. No.: 19/247,555

(22) Filed: Jun. 24, 2025

Related U.S. Application Data
(60) Provisional application No. 63/663,253, filed on Jun. 24, 2024.

(51) Int. Cl. G06Q 50/20

(52) U.S. Cl. CPC G06Q 50/205; G06Q 2220/00

(57) ABSTRACT

A system for educational degree attestation includes a smart contract deployed by an attestation organization on a decentralized platform. A client application is in communication with the decentralized platform and in further communication with an educational facility and a requester. The smart contract is configured to: accept and record enrollment of the educational facility upon payment of a stake; accept student degree information from the educational facility upon payment of a gas cost; accept a degree verification inquiry from the requester upon payment of a verification fee; provide verification for a degree to the requester in response to the inquiry; and disburse the verification fee in part to the educational facility that uploaded the degree and in part to the attestation organization.

### RELATED APPLICATION

This non-provisional utility patent application claims priority to and the benefits of U.S. Provisional Patent Application Ser. No. 63/663,253, filed on Jun. 24, 2024, and entitled “System and Methodology for Academic Degree Attestation Based on Smart Contract,” which application is incorporated herein by reference, in its entirety.

### GOVERNMENT LICENSE RIGHTS

This invention was made with government support from the United States Department of Energy, grant no. DE-FE0031745 and the United States National Science Foundation, grant no. 2215388. The government has certain rights in the invention.

### BACKGROUND

Higher education is a large industry with heavy governmental investment in most countries. In the United States, it is estimated that the total revenue for degree-granting post-secondary educational institutions was, for example, $993 billion in 2020-2021. Among the $993 billion, over $120 billon were state and local governmental funding. Although granting academic degrees to students is not the sole purpose of the higher education industry, it is indisputable that the most important outcome of the heavy investment of both governments and the students is granting and receiving academic degrees. Naturally, it is tempting is to engage in various types of fraud related to academic degrees, which include diploma mills by organizations, and falsified claims of academic degrees or falsified diploma certificates by individuals. While many employers are aware of these issues, most of them do not have the manpower to investigate the claims made by candidates who are applying for jobs.

To address the needs of verification of academic degrees, many companies have bene created to provide real-time or near real-time online verification for employers. In the United States, the one such company for academic degree verification is the National Student Clearinghouse (“NSC”). This company provides a sophisticated online system for schools to upload academic degrees and student enrollment related data, and for employers to register for an account and issue requests for academic degree and enrollment verification. NSC has 3624 higher education institutions enrolled in its system. As such, NSC has become a de facto online platform for academic degree verification in the United States. That said, the system is a traditional centralized system where enrolled schools must submit a large amount of student-related sensitive academic data periodically. Furthermore, the data stored in the system could be altered by internal or external adversaries, which could seriously damage the integrity of the system. Additionally, the data could be leaked or exposed to the public due to cybertheft, which violates the privacy of the students.

Although the blockchain technology cannot address all the potential problems faced by academic degree verification, the integrity of such a system can be greatly strengthened if a large public blockchain is used. As such, various blockchain-based academic degree verification systems have been proposed. However, as we will discuss herein, existing systems suffer from at least two issues: (1) lack of mechanisms to ensure the system's long-term sustainability; and (2) the use of private custom blockchains that do not ensure data immutability, which would defeat the primary purpose of designing a blockchain-based solution.

Although the system and method disclosed herein can be categorized as a decentralized app (“Dapp”), it intentionally does not to use any Web server components and does not to use any off-chain decentralized storage systems such as InterPlanetary File System (IPFS) because such a design would inevitably create single-point of failures. the system and method herein protects the privacy of students, uploads minimum amounts of data to a smart contract, and supports fast verification of academic degrees. Two novel mechanisms are introduced to ensure the usability, security, integrity, and long-term sustainability of the proposed system: (1) participate-by-staking; and (2) pay-to-verify. The participate-by-staking mechanism enables schools to enroll in the system without any human intervention, encourages the participating schools to maintain good academic standards, and also makes it possible to invest the staked funds for future returns. In a way, this mechanism is similar to the principle of the proof of stake consensus algorithm. The pay-to-verify mechanism is the primary mechanism to ensure that the proposed system is financially viable long-term and attractive to schools to participate because it would reward the attestation organization and the participating schools, and cover the cost of operating in the system.

### SUMMARY

According to an embodiment, a system and method for educational degree attestation includes a smart contract deployed by an attestation organization on a decentralized platform. A client application is in communication with the decentralized platform and in further communication with an educational facility and a requester. The smart contract is configured to: accept and record enrollment of the educational facility upon payment of a stake; accept student degree information from the educational facility upon payment of a gas cost; accept a degree verification inquiry from the requester upon payment of a verification fee; provide verification for a degree to the requester in response to the inquiry; and disburse the verification fee in part to the educational facility that uploaded the degree and in part to the attestation organization.

### BRIEF DESCRIPTION OF DRAWINGS

FIG. 1 is an exemplary architecture for a degree attestation system according to the present disclosure.

FIG. 2 is an exemplary custom data structure used to record school related information according to the present disclosure.

FIG. 3 is an exemplary data mapping for keeping track of blacklisted schools according to the present disclosure.

FIG. 4 is an exemplary data structure for storing degrees awarded according to the present disclosure.

FIG. 5 is a flowchart illustrating hashing for an exemplary student identification according to the present disclosure.

FIG. 6 is a table listing exemplary system operations according to the present disclosure.

FIG. 7A is a flowchart illustrating a typical use case for an exemplary system according to the present disclosure.

FIG. 7B is a flowchart illustrating a typical use case for an exemplary system according to the present disclosure.

FIG. 8 is a table listing estimated gas costs for different exemplary functions in a system according to the present disclosure.

FIG. 9 is a scatterplot illustrating the correlation between gas cost and batch size for two different functions in a system according to the present disclosure.

FIG. 10 is a table comparing estimated gas costs for different exemplary operations in a system according to the present disclosure and in the prior-proposed Palma system.

### DETAILED DESCRIPTION

Known Blockchain-based systems designed for academic degree attestation can be roughly divided into two approaches: (1) custom-blockchain; and (2) decentralized applications. In the first approach, a custom-blockchain uses a token to facilitate transactions for the system. In the second approach, smart contracts are used to support key operations for academic degree attestation. To protect the student privacy and to perform access control, a known approach is to use a private or consortium blockchain where the participating schools are supposed to set up blockchain nodes. Unfortunately, such a blockchain system cannot offer data immutability protection because there is no significant barrier against changing the data in the system. Even assuming the participating schools are trustworthy and will not tamper with the data, it is unclear how to incentivize the schools to make the necessary investment to maintain the operations of blockchain nodes, which puts doubt on the long-term sustainability of such systems.

In the second approach, there do not appear to be any known systems that address the long-term sustainability needed for academic attestation. Furthermore, existing solutions in this approach all require certain setup Web components to be deployed on some Web servers. Such Web components do not have the same degree of availability, reliability, and security as large public blockchain systems such as Bitcoin and Ethereum. The present system and methods belongs to and greatly improves upon the second approach by addressing the long-term sustainability issue while offering the usual desirable features, such as privacy protection of student records.

In one exemplary known (proposed) system that uses a custom private blockchain implement academic credential attestation, all pertinent academic records are logged into the blockchain for attestation. While the proposed system could be competing with traditional centralized attestation system, the claim that the proposed system ensures data immutability is technically wrong because a permissioned blockchain is controlled by a single owner. As such, there is no barrier against changing the logged data in the blockchain.

In another exemplary known (proposed) system that uses a custom private blockchain implement academic credential attestation, the custom blockchain uses a token called ECTX as the currency for various operations in the credit transfer process. Although compared to traditional centralized system, this proposed system could be more efficient, the claim that the proposed system is a globally trusted and decentralized system is technically problematic because the blockchain is a permissioned consortium blockchain controlled by one or a limited set of organizations. Again, a common problem with such systems is that they do not impose a high barrier against data modification and they are not truly decentralized.

In a different type of proposed system, a DApp is used for the verification of students' academic degrees and transcripts. Higher educational institutions would upload batched students' academic data to the blockchain for verification. For each batch of students, a Merkel tree is constructed and only the Merkle root is stored in a transaction as part of the blockchain (among other things). For each student in the batch, two groups of data are included, one about the degree awarded to the student (including the name of the student, the name of the institution, the title of the degree, and the year of the degree awarded), and the other about the transcript of the student (including courses taken and the cumulative grade point average). These two groups of data are hashed into a leaf node for the Merkle tree.

For each student included in the batch, two QR codes, one for the degree verification, and the other for the transcript verification, are prepared after the transaction for the batch of students has been mined into a block in the blockchain. One most essential piece of information in each QR code is the authentication path so that the student can be confirmed as the student that is included in the batch of students based on the Merkle root included in the transactions placed on the blockchain. Moreover, this system does appear to include smart contract based degree revocation, because the QR code does not include the smart contract address and the specific function (including the arguments to be used) for checking the revocation list.

Although the above-described system can be space-efficient in terms of the amount of data to be placed on the blockchain, it lacks a mechanism to monetize from the degree verification process, which puts doubt on the long-term sustainability of the system. Furthermore, including the QR code in the issued degree certificate is risking the leak of confidential information, i.e. the student might not be fully informed what is included in the QR code and may easily reveal the QR code (such as proudly posting the degree certification including the QR code in social media). Furthermore, this system lacks a mechanism to blacklist a school after misconduct is detected. In the case a school is blacklisted, every single degree awarded in each batch must be revoked individually, which is inefficient. It should also be noted that in proposed systems such as those described above, encryption is typically not performed in any smart contract due to the high gas cost, even if somehow an encryption key is provided deterministically.

In yet another known proposed system, an attestation architecture controlled the verification of courses taken by students and the corresponding grades. that proposed system was implemented as a DApp on top of Ethereum. The system consisted of claim issuer and claim validator components running separately from Ethereum, and a smart contract deployed on Ethereum to facilitate the attestation process (by recording the account address of the claim validator and the claim issuer). Although the proposed system appears to be technically sound, it is complex and the claim validator could be a single point of failure because that component is not running on top of Ethereum. Furthermore, the details of the smart contract are not disclosed. It is also unclear if the system could accommodate a grade change after the record has been posted in the system.

In one further known proposed system, a set of smart contracts were developed to facilitate academic degree attestation. The disclosure assumed that the smart contracts were deployed and controlled by a regulatory agency in Brazil. The first smart contract was named Authority. The Authority contract allowed the regulatory agency to add an academic institution to the list of schools that can be queries for academic degree attestation, and also to remove any institution from the list. The school information was encoded in a Certificate structure, which included an Ethereum address (representing the school), whether or not the school was registered or revoked, and an expiration time for the Certificate. While it is a practical consideration to set an expiry for the certificate, checking if the certificate has expired makes the contract vulnerable to the timestamp dependency vulnerability. A second smart contract, named Curriculum, was created for each registered school. The school was expected to register each student in the school, and every course a student has taken using two Solidity mappings. When a student has fulfilled all the course requirements toward a degree, a Diploma smart contract instance is created. If there is a Diploma contract for a student, then the student is proved to have earned a degree at the particular school.

Finally, in one further set of proposals, a set of smart contracts facilitated academic degree attestation where IPFS was used to store the actual certificates or where the smart contracts deployed on Ethereum and IPFS was used to facilitate the academic certificates management and attestation. The details of the smart contracts were not disclosed.

In light of the many shortcomings discussed above for know proposed systems, the present system and method aims to improve upon known systems solve problems with known systems by achieving several goals. First, the system should be easy to maintain with minimum human intervention. Second, the system should protect the privacy of the students while allowing the attestation of the degrees earned by a student. Third, the system should use Web components to avoid single-point failures, and fourth the system should be conducive for long-term sustainability. With these goals in mind, the following system and method is described.

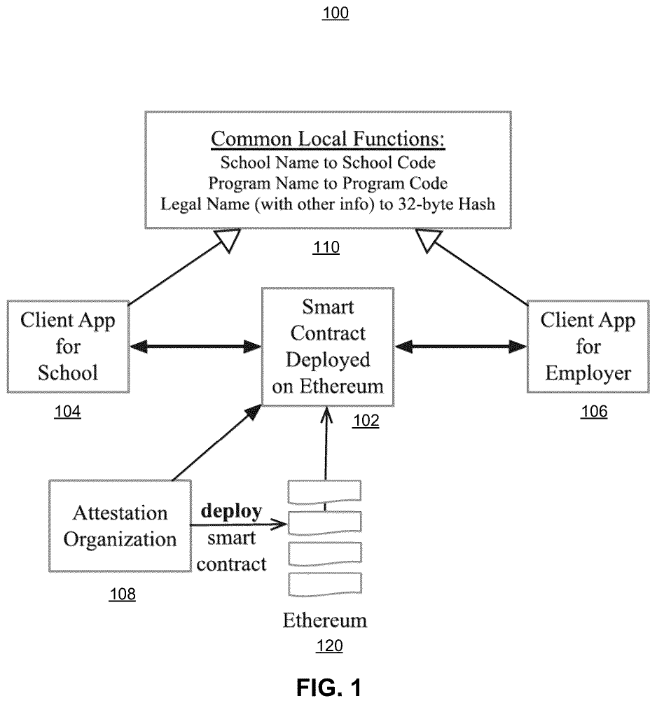

FIG. 1 depicts an exemplary architecture for a system 100 according to the present disclosure. The system 100 consists of a smart contract 102 deployed on the Ethereum platform 120, and a client component that can be customized into a school client application 104 and an employer client application 106. The client applications 104 and 106 share a set of common local functions, 110, which include but are not limited to, a function to convert a school name to a predefined school code, a function to convert a program name to a predefined program code and a function to convert a legal name (with other information) to 32-byte hash. The client applications 104 and 106 maybe part of the same or different application and maybe either installed software on a computer or portable electronic device or a web-based application.

The system intentionally does not follow the traditional web3 design for developing decentralized applications, which would have to rely on a Web server and a decentralized file storage system (such as IPFS). As such, the present system is more lightweight, easier to deploy and maintain, and incurs less gas cost. In the system 100, the client applications 104 and 106 interact with the deployed smart contract 102 directly without the need of any Web server. The system 100 stores a minimum amount of data for the attestation of academic degree awarded by each enrolled school on the smart contract. The smart contract 106 is deployed by an attestation organization 108 via the decentralized platform 120.

It should be appreciated that in the above example, Ethereum is chosen as the decentralized platform 120 for academic degree attestation, but other blockchain-based platforms with smart contract capability may also suffice so long is it meets the capabilities set forth herein. Specifically, in the exemplary system 100, a single smart contract 102 is deployed by the attestation organization 108 for academic degree attestation. All degree data uploaded by the schools are stored in the smart contract 102. The decentralized platform 120 is used to ensure: (1) the data uploaded to the smart contract is immutable for all practical purposes and (2) the rules specified by the smart contract are also adhered to during the operation of the proposed system. These two properties ensure the integrity and trustworthiness of the proposed system for academic degree attestation.

The attestation organization 108 is in charge of setting up and maintaining data relating to degree attestation in the system. This entity designs and deploys the smart contract 102. Furthermore, this entity maintains a list of reputable schools that offer academic degrees, and may conduct investigations regarding the practices of these schools. When a school is found to have serious misconduct, the schools may be blacklisted form participating in the system. In one example, the attestation organization 108 may be funded by employers that use the proposed platform for academic degree verification in the form of verification fees.

It is contemplated that mainly higher educational institutions will wish to participate in the proposed system, but it should be appreciated that other technical schools or lower schools may also wish to participate. The system 100 is well suited for higher educational institutions because they offer accredited academic programs and the institutions are also accredited. For example, in one embodiment, a participating school is expected to place a significant stake in the system while enrolling into the system. The school may also be expected to pay for the gas cost while uploading the academic degree data of the students. It should be understood that the system should provide strong incentives for any school to participate. There is an assumption that there would be a large number of employers relying on the proposed system to verify academic degrees as claimed by the students who are applying for jobs. The system 100 could charge a small fee for each verification request from an employer. In some examples, half of the verification fee could be credited to the participating schools immediately with each verification request. If such a monetization scheme is used, it is estimated that royalties collected by each participating school could significantly exceed the cost of enrolling in the system and the cost of uploading degree data to the system in the long term.

Employers could use the present system to verify the academic degrees claimed by students who are applying for jobs. An employer could, for example, first check if the school from which the student obtained an academic degree has already joined the attestation system. This step could be free to all employers. If the school is a participant, then the employer would call the smart contract to verify if the claimed degree is true by paying a verification fee.

Turning now to a detailed description of the system's functionality and components, the smart contract 102 uses a set of data structures to store the school information. As explained more fully below, the data structure may include, for example, an address for the school in the decentralized platform 120, as well as the degree information (awarded as well revoked degrees). The data structures herein are designed in a way that ensures a minimum amount of data are stored at the smart contract 102 without the necessity of using off-chain storage for attestation of the degrees.

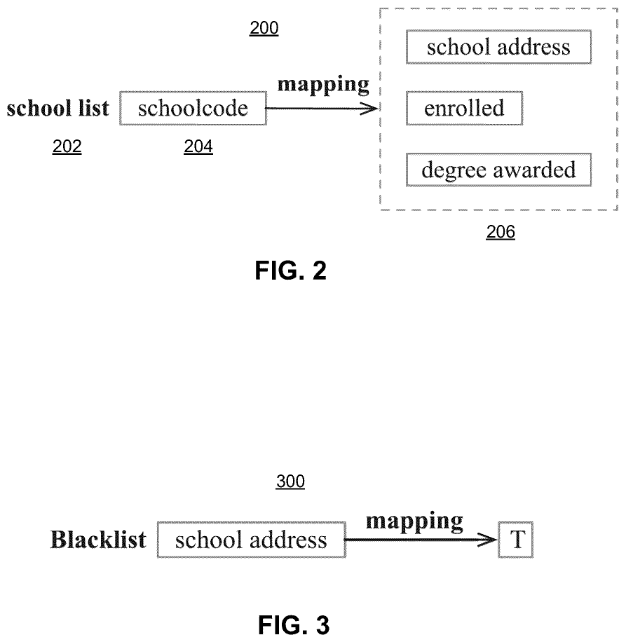

FIG. 2 depicts an exemplary custom structure 200 used to record school related information. As shown in FIG. 2, a smart contract maintains a list of enrolled schools 202, where each school is mapped to this structure based on the 6-byte school code 204. The school structure 206 contains the decentralized platform address, a Boolean flag indicating whether or not the school is currently enrolled, and all the academic degrees awarded using a multi-level mapping.

The smart contract 102 may use an exemplary mapping 300 to keep track of the blacklisted schools, as shown in FIG. 3. Each school is again identified by a 6-byte school code. If there is an entry of a school code that maps to a true value, then the school is considered blacklisted.

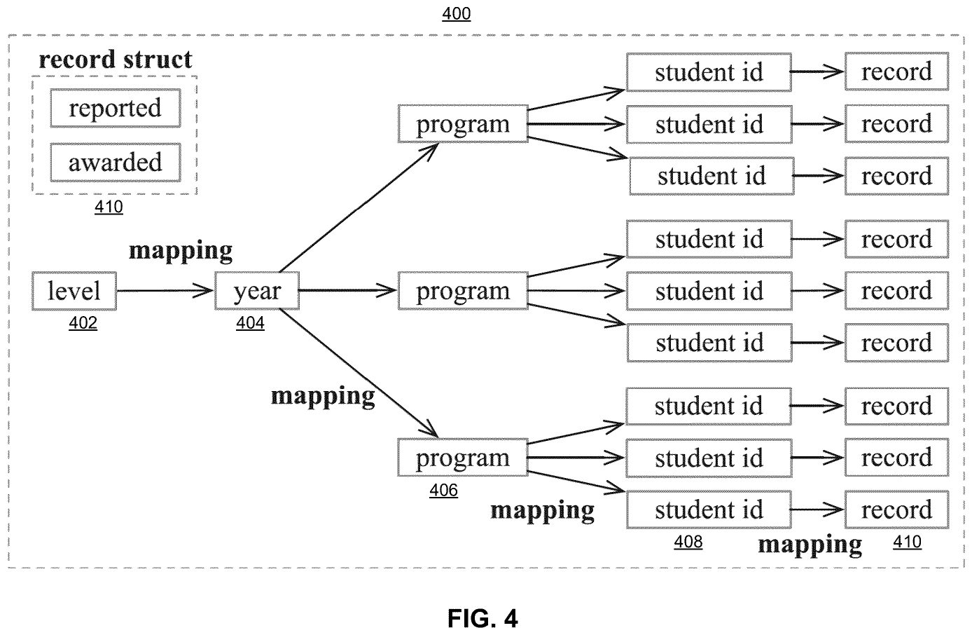

FIG. 4 depicts an exemplary data structure 400 to store degrees awarded data, which contains several levels of mappings to facilitate efficient access to a degree awarded to a particular student. In the example, the first aspect of the mapping is based on the level 402 of the degrees awarded. For example, a single byte may be used to denote the level of the degree, which could be Bachelor, Master, Doctoral, etc. (other degrees, such as an associate degree may be added if desired). The next aspect of mapping is based on the year of the degree awarded 404, which may be encoded using four bytes. The next aspect of mapping is the degree program 406, based on the program code, which may be encoded using six bytes. (For simplicity, the reference numerals 406, 408, and 410 in FIG. 4 are depicted only for one branch of the mapping but apply also to like aspects of different branches). The final aspect of mapping is based on a 32-byte long student identifier 408, which points to a degree record structure 410. The degree record structure 410 may consist of two Boolean fields indicating if the degree for this particular student has been reported, and if the degree has been awarded or revoked. Note that a degree may first be reported for a student, and then revoked. The degree record would reflect the status about the degree.

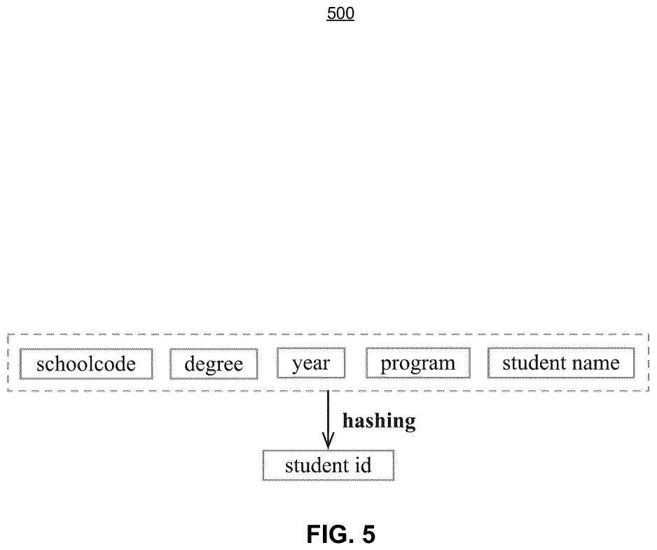

The student identifier 408 may be obtained by hashing the student's legal name in conjunction with the other information, such as the school code, the degree name, the year of the degree awarded, and the program studied. An exemplary data structure 500 for a student identifier is depicted in FIG. 5.

In one embodiment, when verifying a degree, a student may be asked to provide the school name, program name, the year of the degree awarded, the level of degree, as well as the legal name. Once all such information becomes available, the student identifier can be produced. Then the degree record may be retrieved from the enrolled school data stored in the smart contract. It is possible that no degree record is found because either the school somehow failed to upload the record, or there is no such student. Regardless the reason, the system would report back that the degree information is unreported (i.e. unknown). If a degree record is found, then the actual status of the degree is returned (i.e. could be awarded or revoked).

The advantages of this design are two-fold: (1) by only storing the student identifier, the privacy of the student is protected, i.e. the public data in the smart contract contains no identifiable information regarding any particular student; (2) by only storing the student identifier in comparison with storing the entire set of identification and academic data (student full name, program, and the year of the degree awarded, etc.), much less gas consumption is incurred, which reduces the long-term financial cost of operating in the attestation system.

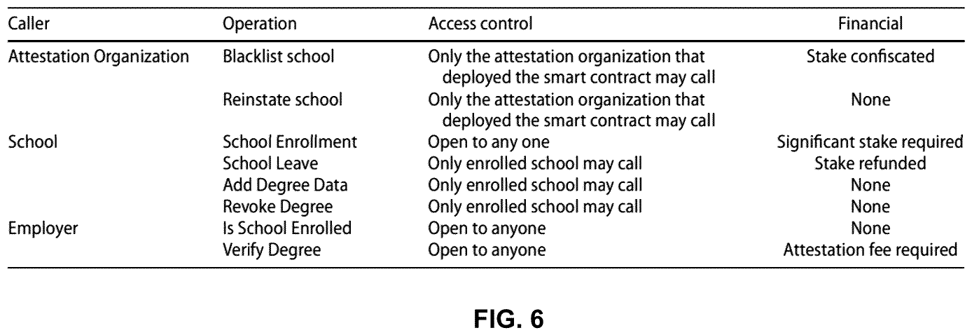

Turning now to specific functionality for the present system, FIG. 6 depicts a table of exemplary functions that that can be called by a caller (e.g., the attestation organization, the school or the prospective employer) to effectuate the processes discusses above and which will be described in more detail below. It should be understood that the function names used herein are merely exemplary.

To ensure the security of the attestation process, the calls to the smart contracts are regulated in two ways: (1) access control, i.e., only authorized users are allowed to call and (2) the caller would have to pay for the right to call a function defined in the smart contract. The first method is for an attestation organizer and for enrolled schools. The second method is used for users to get admitted to the system, or to use the service provided by the smart contract. Only one function defined in the smart contract, IsSchoolEnrolled, can be called by anyone without access control and without having to pay, which is a read-only operation.

It may be assumed that the attestation organization has access to a list of reputable higher educational institutions. For example, schools that offer accredited engineering programs can be obtained from the Accreditation Board for Engineering and Technology (ABET). It is further assumed that the attestation organization would encourage schools to enroll in the attestation service via traditional communication channels such as advertising, emails and phone calls. While it is possible to establish traditional contractual agreements between schools and an attestation organization, that process is time-consuming and costly. As such, the present system offers a public function in the smart contract for any school on the list to enroll directly.

To mitigate possible abuses and attacks (such as impersonating a legitimate school), any school that invokes the Enroll function must place a significant stake. If an adversary impersonates a legitimate school, once reported by the actual school, the impersonating school account will be blacklisted, the stake placed will be confiscated, and the actual school will be allowed to enroll. This stake-based mechanism should constitute a barrier against such attacks. The mechanism would also encourage good behavior in awarding academic degrees because the stake placed could also be confiscated of a school is found to have serious misconduct in awarding academic degrees (e.g., a degree mill).

It is contemplated that a school may choose to leave the attestation organization at any time as long as it has not been blacklisted. The stake placed by the school would be refunded in full. The school can no longer upload academic degree data once it has left the system. However, the data uploaded previously would be maintained in case the school would want to rejoin the system at a later date.

In an embodiment, only the attestation organization (i.e. the address that deploys the smart contract) may invoke the BlacklistSchool operation. Once a school is blacklisted, the stake placed by the school (or someone impersonating the school) will be confiscated. More specifically, because the system is open for anyone to enroll, it cannot blacklist a school based only on the school code. Otherwise, an adversary could prevent a legitimate school from enrolling in the system by losing the stake placed. Instead, the decentralized platform (e.g., Ethereum) address used to enroll is blacklisted. An adversary is inherently discouraged from repeatedly enrolling with a stake because the adversary would lose the stake each time it is blacklisted.

To reinstate a blacklisted school, the attestation organization, and only the attestation organization, may call the ReinstateSchool operation. The attestation organization would call this operation when the blacklisted school has taken proper actions to address previous misconduct.

In an embodiment, an enrolled school may upload degree data by calling the addDegreeData function. The calling school must provide the school code, and provide degree data, including the program code, the year of the degree offered, the level of degree (bachelor's, master's, and doctoral), and a list of 32-byte hashes representing the list of students who received the degree. The client application 104 would translate the school name into a 6-byte school code, the program into a 6-byte program code, and the student legal name (among other information provided) into a 32-byte hash as the student identifier. An enrolled school may decide to revoke the degree awarded to a student by calling the revokeDegree function. The calling data are identical to those of the addDegreeData function and the only difference is to revoke the degrees awarded previously to these students.

In an embodiment, the system includes a read-only IsSchoolEnrolled function that an employer may first check if a school is currently enrolled in the attestation system. Normally, the employer would proceed to verify a degree only if the school is currently enrolled. An employer may call the verifyDegree function to verify if a student indeed has a degree using the detailed degree data provided by the student, including the school, the program, the level of degree, the year of degree awarded, and the full legal name. The proposed client application 106 would translate the school name into a 6-byte school code, the program into a 6-byte program code, and the student legal name (among other information provided) into a 32-byte student identifier. The employer would then use this student identifier to call the verifyDegree function defined in the smart contract and pay a fee to confirm whether or not the claimed degree is the true. The function could return three different statuses: (1) awarded; (2) revoked; and (3) unreported. If the response is unreported, the system could refund the verification fee to the employer because it could be due to the school's failure to report its degrees awarded promptly.

In an embodiment, the verification fee paid by the employer can be divided into half. Half of the fee would be credited to the school that issued the degree as royalty, and half of the fee will be collected to support the operations of the attestation organization.

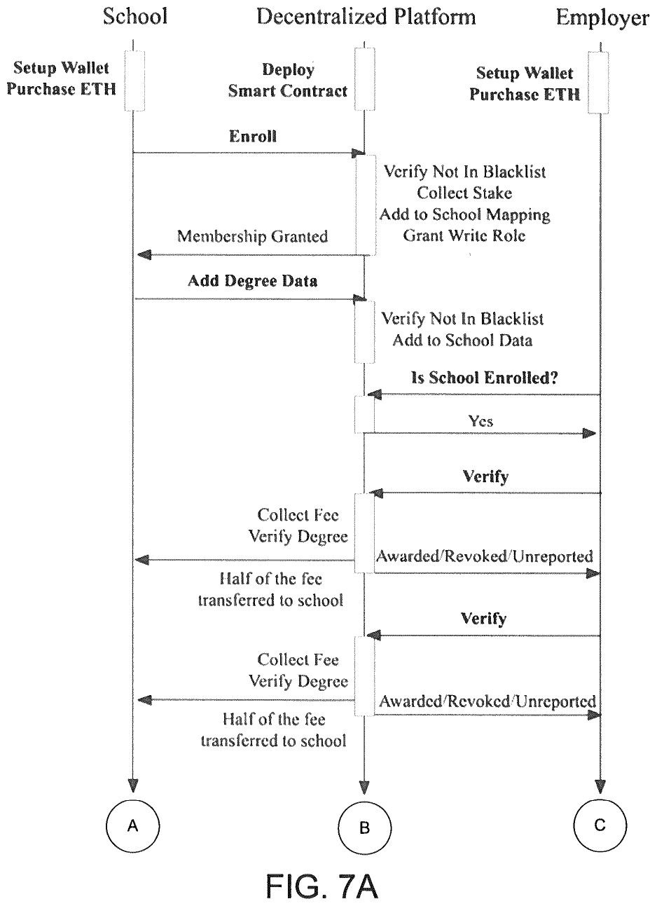

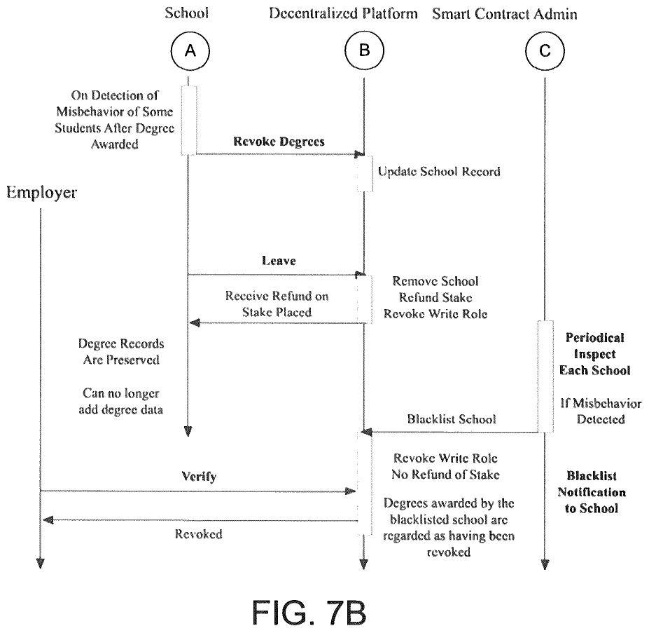

FIG. 7 illustrates an exemplary typical use case for the an embodiment of the present system and method using Ethereum as the decentralized platform. To use the system, a school or an employer would need to install and setup an Ethereum wallet and purchase sufficient amount of ETH, which is the cryptocurrency coin offered by Ethereum. The school would then call the Enroll function defined in the smart contract to enroll in the system. To demonstrate the commitment of running quality academic degree programs and only award degrees to students who have completed the required curriculum with satisfactory grade point average (GPA), the school must place a substantial amount of stake in ETH. This participate-by-staking mechanism would create a barrier against institutions that run degree mills by confiscating the staked funds and blacklisting them once evidence is found for such poor behaviors. Note that only a school that has been pre-identified by the attestation organization may enroll.

Once a school has been enrolled in the system, the school may call the smart contract to upload data regarding degrees awarded. Due to the gas limit imposed by Ethereum, a school may have to divide the data into multiple batches and upload them to the system several times. To verify whether the academic degree claimed by a student is true, an employer would first check if the degree granting school is already part of the system. If so, the employer would then call the Verify function of the smart contract and pay a fee. Half of the fee is credited to the school immediately.

A participating school could uncover facts that one or more students have engaged in significant academic misconduct that warrants the revocation of their degrees. If so, the school would call the RevokeDegree function defined in the smart contract to label the particular degrees as invalid. A participating school may choose to leave the system for any reason by calling the Leave function defined in the smart contract and receiving the stake placed when enrolling in the system.

It is also possible that a school engaged in unacceptable practices in granting academic degrees to students without the necessary academic standard. When such bad behavior has been uncovered, the attestation organization would choose to blacklist the misbehaving schools by calling the blacklistSchool function defined in the smart contract. A school that has been blacklisted may be reinstated (by calling the reinstateSchool function) after the school has demonstrated sufficient evidence that academic standards have been maintained and problematic issues have been resolved. The degree data uploaded by a school that has been blacklisted will not be removed. However, if an employer calls the isSchoolEnrolled function for the school, false would be returned indicating that the degree has been revoked.

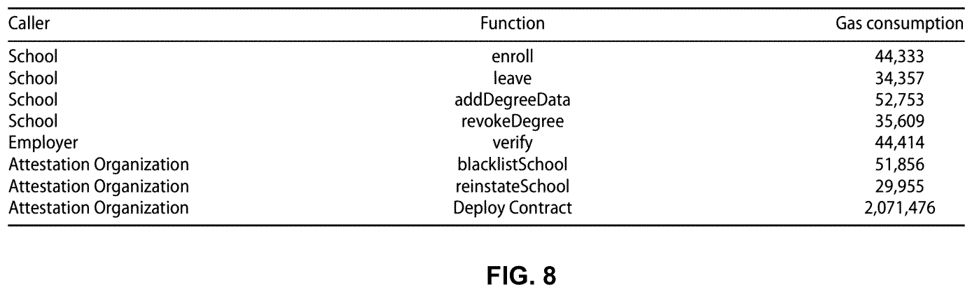

The present system has been tested and found to be an effective improvement over known systems described earlier herein. Specifically, the system has been evaluated using the Truffle Suite, which offers a comprehensive suite of tools for smart contract development, and Ganache, which simulates the Ethereum environment, to validate the smart contract and to assess the gas consumption. Evaluating gas consumption is useful because for the operations on the proposed smart contract because the attestation operations are generally insensitive to latency. FIG. 8 summarizes the gas consumption for all functions defined in the proposed smart contract. For the addDegreeData and the revokeDegree functions, the gas consumption for a single student is shown.

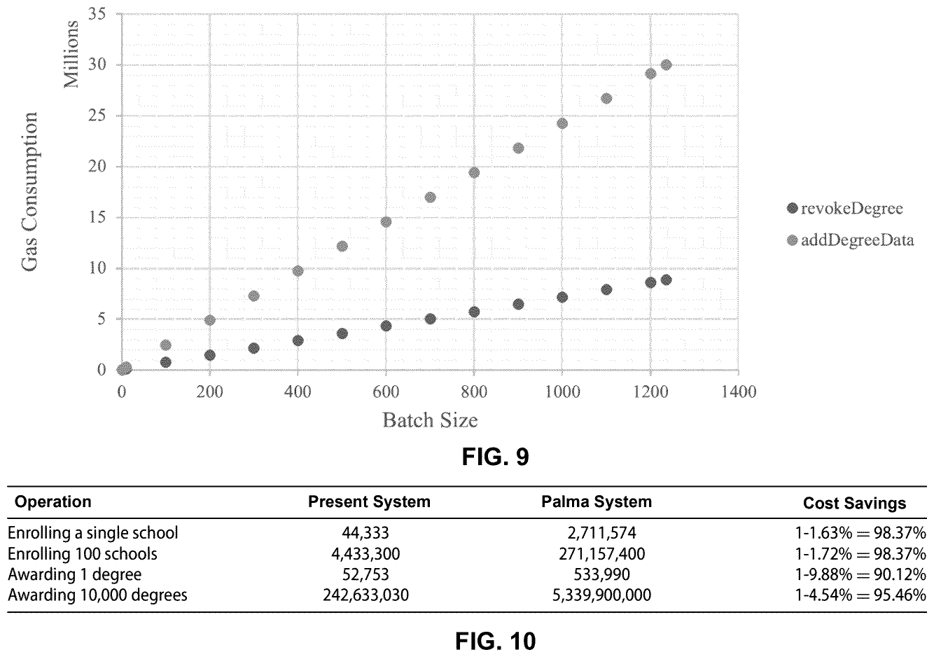

The functions for uploading degrees awarded and for revoking degrees are designed to allow batch processing. Due to the gas consumption limitation imposed on each block by Ethereum (i.e. 30,000,000), there is an upper-bound on the batch size. Based on experimentation, for the addDegreeData function, the upper-bound of the batch size was found to be 1236, where the gas consumption for the call was 29,983,046. Because very few programs would graduate more than 1,000 students in a year, a single call would be able to upload all the degree records per program for most academic institutions. The gas consumption versus the batch size for both the addDegreeData and the revokeDegree functions are shown in FIG. 9. It should be noted that it is rare for a school to revoke degrees for many students. As can be seen in FIG. 9, the cost of adding one student in a batch for the addDegreeData function is significantly more than that for revoking the degree for an additional student. The additional gas consumption for each student in the addDegreeData function (for batch processing) is about 24,235, while the additional gas consumption for each student in the revokeDegree function is only about 7134. The drastic difference is because for the addDegreeData function, an additional mapping needs to be created, while for the revokeDegree function, only an existing mapping needs to be re-written.

The present novel system was also tested against a known prior design by Palma et al., Blockchain and Smart Contracts for Higher Education Registry in Brazil. Int J Netw. Manag. 2019; 29(3):e2061; doi: 10.1002/nem.v29.3 (“Palma”). In Palma, an Authority contract is in charge of enrolling and blacklisting schools, and verifying that a school is still an active member of the system. When a school is enrolled in the system, an instance of another contract Curriculum is created for the particular school. The school then could upload data regarding each student's discipline and progress toward the degree to this smart contract. When the student has completed the curriculum for the program, an instance of the Diploma contract will be created just for the particular student. If serious misconduct is found after the diploma has been issued, the school may call the particular instance of the Diploma contract to revoke the degree.

While this design covers common scenarios, it is very expensive in terms of space utilization and gas consumption. One Curriculum is created for every school enrolled in the system, and one Diploma contract is created for every student that graduated with a degree from the school. If 100 schools enrolled in the system, 100 Curriculum contracts will be created. If each school has 10,000 students graduated in each year, then 10,000 Diploma contracts will be created for every school, and the system would create 1,000,000 Diploma contracts total. A detailed comparison of gas costs and a calculation of savings over Palama for enrolling schools and awarding degrees is shown in FIG. 10. As can be seen, the gas cost savings of the present inventions over Palma is significant.

One often overlooked, but very important design consideration of a long-running system such as the present system is the financial sustainability of the system. While some studies have considered this perspective, the use of custom blockchain would lead to other sustainability problems. For example, it is unclear who will be paying for the setup and who maintenance of the blockchain nodes long-term. The DApps designed for academic degree attestation failed to consider this issue in large part. The present system addresses the long-term sustainability issue with two mechanisms: (1) a participate-by-staking mechanism; and (2) a pay-to-verify mechanism. The first mechanism would not only force the participating schools to maintain good academic standards, but would also make it possible to invest the staked funds for future returns. The second mechanism could reward the attestation organization and the participating schools, and cover the cost of operating in the system.

Consider a participating school that grants 10,000 degrees per year. Assume that the school could batch the degree data in 10 calls to the addDegreeData function. The total gas consumption per year would be 242,633,030. Using an exemplary ETH price of $2,362 (as of Feb. 6, 2024) and the gas price of 30 gwei, 1 gas would be worth 30×$0.000002362=$0.00007086. The total cost for paying for the gas consumption in one year would be 242,633,030×$0.00007086=$17,192.98. Assume that the verification fee is set to be 100,000,000 gwei, which is about $23.62. If the income is split 50-50 between the attestation organization and the school, then the school would collect $11.81 for each verification request. If there is one verification made per year for each student graduated, the total net income per year for the school would be 10,000×$11.81-$17, 192.98=$118, 100-$17, 192.98=$100,917.02, which would constitute a significant incentive for the schools to join the system.

The income collected by the attestation organization would enable the organization to conduct its own investigation on the academic behaviors of the participating schools to protect the reputation of the system, and to make further improvements to the system.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Accordingly, departures may be made from such details without departing from the spirit or scope of the applicant's general inventive concept.

1. A system for educational degree attestation, the system comprising:
a smart contract deployed by an attestation organization on a decentralized platform;
a client application in communication with the decentralized platform and in further communication with an educational facility and a requester;
wherein the smart contract is configured to do the following:
accept and record enrollment of the educational facility in the system upon payment of a stake by the educational facility;
accept student degree information from the educational facility after enrollment and upon payment of a gas cost associated with upload of the student degree information by the educational facility;
accept a degree verification inquiry from the requester upon payment of a verification fee by the requester;
provide verification for a degree to the requester in response to the inquiry; and
disburse the verification fee in part to the educational facility that uploaded the degree and in part to the attestation organization.

2. The degree attestation system of claim 1, wherein the smart contract is further configured to accept a request to revoke student degree information previously uploaded by the educational facility upon payment of a gas cost associated with the revocation.

3. The degree attestation system of claim 1, wherein the smart contract is further configured to assign a status to each uploaded student degree indicating whether such degree is at least awarded, revoked or unreported.

4. The degree attestation system of claim 3, wherein the smart contract is further configured to:
accept a request from the attestation organization to designate the educational facility as blacklisted;
confiscate the stake paid by the educational facility; and
change the status of all degrees uploaded by the educational facility to revoked.

5. A method for educational degree attestation, the method comprising:
deploying a smart contract on a decentralized platform;
providing an application for connection to the decentralized platform by an educational facility and a requester;
wherein the smart contract is configured to do the following:
accept and record enrollment of the educational facility in the system upon payment of a stake by the educational facility;
accept student degree information from the educational facility after enrollment and upon payment of a gas cost associated with upload of the student degree information by the educational facility;
accept a degree verification inquiry from the requester upon payment of a verification fee by the requester;
provide verification for a degree to the requester in response to the inquiry; and
disburse the verification fee in part to the educational facility that uploaded the degree and in part to the attestation organization.

6. The method of claim 5, wherein the smart contract is further configured to accept a request to revoke student degree information previously uploaded by the educational facility upon payment of a gas cost associated with the revocation.

7. The method of claim 5, wherein the smart contract is further configured to assign a status to each uploaded student degree indicating whether such degree is at least awarded, revoked or unreported.

8. The method of claim 7, wherein the smart contract is further configured to:
accept a request from the attestation organization to designate the educational facility as blacklisted;
confiscate the stake paid by the educational facility; and
change the status of all degrees uploaded by the educational facility to revoked.

9. A method for educational degree attestation using a smart contract deployed on a decentralized network, the method comprising:
accepting and record enrollment of an educational facility in the system upon payment of a stake by the educational facility;
accepting student degree information from the educational facility after enrollment and upon payment of a gas cost associated with upload of the student degree information by the educational facility;
accepting a degree verification inquiry from a requester upon payment of a verification fee by the requester;
providing verification for a degree to the requester in response to the inquiry; and
disbursing the verification fee in part to the educational facility that uploaded the degree and in part to an attestation organization that investigates the educational facility.

10. The method of claim 9, further comprising accepting a request to revoke student degree information previously uploaded by the educational facility upon payment of a gas cost associated with the revocation.

11. The method of claim 9, further comprising assigning a status to each uploaded student degree indicating whether such degree is at least awarded, revoked or unreported.

12. The method of claim 11, further comprising:
accepting a request from the attestation organization to designate the educational facility as blacklisted;
confiscating the stake paid by the educational facility; and
changing the status of all degrees uploaded by the educational facility to revoked.
